(19) United States
(12) Patent Application Publication
(10) Pub. No.: US 2024/0410654 A1
(43) Pub. Date: Dec. 12, 2024

(54) HEAT EXCHANGER ASSEMBLY FOR A MOTOR VEHICLE

(71) Applicant: Ford Global Technologies, LLC, Dearborn, MI (US)

(72) Inventors: Morten Pyroth, Leverkusen (DE); Tobias Duffe, Köln (DE); Christian Jolk, Cologne (DE); Thomas Nitsche, Neuss (DE); Maximilian Klein, Düsseldorf (DE)

(73) Assignee: Ford Global Technologies, LLC, Dearborn, MI (US)

(21) Appl. No.: 18/737,149

(22) Filed: Jun. 7, 2024

(30) Foreign Application Priority Data
Jun. 9, 2023 (DE) 102023115126.6

(51) Int. Cl. F28D 1/047; B33Y 80/00; F28D 21/00; F28F 1/10

(52) U.S. Cl. CPC F28D 1/0472; F28F 1/10; B33Y 80/00; F28D 2021/008; F28F 2215/00

(57) ABSTRACT

A heat exchanger assembly for a motor vehicle includes an inflow side, an outflow side, and at least one helically extending heat exchanger tube through which a heat exchanger fluid flows. A medium flows along a throughflow direction from the inflow side to the outflow side. A helix axis of a helix formed by the heat exchanger tube extends transversely with respect to the throughflow direction of the heat exchanger assembly.

### CROSS-REFERENCE TO RELATED APPLICATION

This application claims priority to and the benefit of German Patent Application No. 102023115126.6, filed on Jun. 9, 2023. The disclosure of the above application is incorporated herein by reference.

### FIELD

The present disclosure relates to a heat exchanger assembly for a motor vehicle.

### BACKGROUND

The statements in this section merely provide background information related to the present disclosure and may not constitute prior art.

Heat exchangers are installed in motor vehicles in order, for example, to cool a heat exchanger fluid, for example a cooling liquid of an internal combustion engine. Such heat exchangers are also provided in electrically powered motor vehicles. In order to be cooled, the heat exchanger fluid is conducted through the heat exchanger while the heat exchanger is impinged on or flowed through by a medium, commonly air, in particular relative wind. Such a heat exchanger is thus a liquid-air heat exchanger, which generally has heat exchanger tubes in the form of round tubes, flat tubes or oval tubes, through which the heat exchanger fluid flows and which are surrounded by a plate or fin structure of the heat exchanger, which structure contributes to dissipating heat from the heat exchanger tubes by heat conduction and transferring the heat by convection to the air that flows through. Round tubes exhibit less of an internal pressure drop than flat tubes. However, round tubes provide a relatively small internal surface area for the exchange of heat, and, in standard, are furthermore limited in terms of their length by end tanks that are connected to the ends of the heat exchanger tubes. By contrast, flat tubes offer a high ratio of surface area to liquid volume, but exhibit a large internal pressure loss.

CN 103 712 505 A discloses a heat exchanger assembly having heat exchanger fins in a stellate arrangement and having helical heat exchanger tubes that extend through the heat exchanger fins. Air can flow through the assembly, wherein a throughflow direction of the assembly extends parallel to a helix axis of helices formed by the heat exchanger tubes.

CN 201 037 693 Y discloses a heat exchanger assembly which has a housing having a lower gas inlet and an upper gas outlet and which has two water tanks having a cold-water inlet and a hot-water outlet, which water tanks are positioned at the two ends of the housing and are connected to the housing. The assembly furthermore has a multiplicity of spiral-shaped heat exchanger tubes which are arranged parallel to one another within the housing and the ends of which are connected to the two water tanks. The assembly has a throughflow direction in which a gas can flow from the gas inlet to the gas outlet, wherein the throughflow direction extends parallel to a helix axis of the helix formed by the heat exchanger tubes.

U.S. Pat. No. 10,782,072 B2 discloses a heat exchanger assembly having multiple spiral heat exchangers, wherein each spiral heat exchanger has an outer tube and, inserted therein, a thermally conductive tube insert of helical form.

US 2011/0240266 A1 discloses a heat exchanger assembly having an outer tube, having an inner tube that is concentric with respect to the outer tube, and having a spiral-shaped structure arranged between the outer tube and the inner tube.

### SUMMARY

This section provides a general summary of the disclosure and is not a comprehensive disclosure of its full scope or all of its features.

The present disclosure provides a more effective heat exchanger assembly, which exhibits less of an internal pressure loss in the heat exchanger fluid.

In one form, a heat exchanger assembly for a motor vehicle is presented. The heat exchanger assembly has an inflow side, an outflow side and at least one helically extending heat exchanger tube through which a heat exchanger fluid can flow or flows. A medium flows along a throughflow direction from the inflow side to the outflow side. A helix axis of a helix formed by the heat exchanger tube extends transversely with respect to the throughflow direction of the heat exchanger assembly.

Note that the features and measures individually specified in the following description may be combined with one another in any technically meaningful way and reveal further refinements of the disclosure.

In one form, use is not made of a rectilinear heat exchanger tube, such as is conventional. Instead, the heat exchanger tube according to the present disclosure extends helically, such that, in relation to a rectilinear heat exchanger tube, a heat exchanger tube that is longer in its developed form can be arranged in a structural space of a specified and fixed size, thus increasing a throughflow length for the heat exchanger fluid. Larger surface areas for the exchange of heat can thus be provided with the heat exchanger assembly according to the present disclosure, which makes the heat exchanger assembly according to the present disclosure much more efficient with regard to this exchange of heat than a conventional heat exchanger assembly of the same structural size but with rectilinear heat exchanger tubes. Furthermore, owing to the centrifugal force acting on the heat exchanger fluid flowing through, the helical profile of the heat exchanger tube generates continuous changes in direction of the heat exchanger fluid flowing within the heat exchanger tube in such a way that the heat exchanger fluid is thoroughly mixed. The heat exchanger fluid can thus make a greater contribution to the transfer of heat than, for example, in the case of a flow in a rectilinearly extending tube.

To be able to fully use this effectiveness of the heat exchanger assembly according to the present disclosure, the helix axis of the helix formed by the heat exchanger tube extends transversely with respect to the throughflow direction of the heat exchanger assembly. The heat exchanger tube is thus impinged on laterally by a medium, in particular by air, which correspondingly flows around the heat exchanger tube. Here, the medium, that is to say in particular the air, flows into the heat exchanger assembly via the inflow side thereof, subsequently flows around the at least one heat exchanger tube, and exits the heat exchanger assembly via the outflow side of the heat exchanger assembly. The inflow side and/or the outflow side of the heat exchanger assembly may in this case take the form of a planar or curved surface which, when the heat exchanger assembly has been arranged as intended in a motor vehicle, may be oriented vertically and for example so as to extend in a vehicle transverse direction. The throughflow direction of the heat exchanger assembly, which is defined by the structural design of the heat exchanger assembly, may extend rectilinearly through the heat exchanger assembly and, when the heat exchanger assembly has been arranged as intended in a motor vehicle, may be oriented horizontally, for example in a vehicle longitudinal direction.

In another form, the heat exchanger assembly according to the present disclosure may have a heat exchanger tube configured and arranged according to the present disclosure, or multiple such heat exchanger tubes. The statement that the at least one heat exchanger tube extends helically means in particular that a tube centerline of the heat exchanger tube defines a helix. The helix axis is in this case rectilinear, that is to say is not curved, and extends in the center of the helix. The heat exchanger fluid that can be conducted through the heat exchanger tube may be liquid or gaseous.

Owing to the relatively expansive design and arrangement of the heat exchanger tube according to the present disclosure, the heat exchanger assembly according to the present disclosure can have a greater depth than a conventional heat exchanger assembly with rectilinear heat exchanger tubes, and this likewise has a positive impact on the effectiveness of the heat exchanger assembly according to the present disclosure. Here, the inflow side of the heat exchanger assembly may form a front side of the heat exchanger assembly, and the outflow side of the heat exchanger assembly may form a rear side of the heat exchanger assembly, wherein the depth of the heat exchanger assembly extends from the front side to the rear side.

In yet another form, the heat exchanger assembly according to the present disclosure may have at least two fluid distributors which may be communicatively connected to ends of the heat exchanger tube or of the heat exchanger tubes in order to be able to feed and discharge the heat exchanger fluid to and from the individual heat exchanger tubes.

In one form, the heat exchanger assembly according to the present disclosure is suitable in particular for use in a motor vehicle. For example, the heat exchanger assembly may be used for cooling an internal combustion engine, the cooling liquid of which is conducted as heat exchanger fluid through the heat exchanger assembly. Alternatively, the heat exchanger assembly according to the present disclosure may be used for heating and/or cooling a refrigerant of a functional unit of a motor vehicle, and in so doing be used as a condenser and/or evaporator. The heat exchanger assembly may also be used in electric vehicles and/or hybrid vehicles.

In one form, the heat exchanger assembly has at least one heat exchanger fin that extends transversely with respect to the helix axis. The heat exchanger fin may consist of a metal or a metal alloy and may be rectilinear or curved. The heat exchanger fin may in particular extend parallel to the through flow direction of the heat exchanger assembly. The heat exchanger assembly may also have two or more, in particular a multiplicity of, heat exchanger fins which are spaced from one another in a row along the helix axis of the heat exchanger and which may be oriented at least partially parallel to one another. The heat exchanger fins yet further enlarge the effective surface area of the heat exchanger assembly.

In another form, the heat exchanger assembly has at least two heat exchanger tubes which are configured, and arranged relative to one another, so as to define a common helix axis. The heat exchanger tubes loop around one another. The effective surface area of the heat exchanger assembly is thus yet further enlarged. The heat exchanger assembly may also have three or more heat exchanger tubes, which define or have the same helix axis. If two such heat exchanger tubes are provided, they may be arranged offset with respect to one another by 180° about the common helix axis so as to form a double helix. If three such heat exchanger tubes are provided, they may be arranged offset with respect to one another by 120° about the common helix axis. If four such heat exchanger tubes are provided, they may be arranged offset with respect to one another by 90° about the common helix axis. Here, if the heat exchanger tubes are of identical design, the heat exchanger tubes are, in effect, distributed uniformly about the 360° defined by the common helix axis. The correspondingly interwound heat exchanger tubes furthermore give rise to relatively high structural rigidity of the heat exchanger assembly, which is increased yet further if the heat exchanger tubes are combined with the aforementioned heat exchanger fins. Furthermore, correspondingly interwound heat exchanger tubes allow conventionally used end tanks to be decreased in size or even omitted entirely.

In yet another form, the heat exchanger assembly has at least two heat exchanger tubes, the helix axes of which, as viewed in a vertical direction, extend parallel to one another and are spaced from one another such that the heat exchanger tubes loop around one another at uniform intervals along the helix axes. The heat exchanger tubes are thus, in effect, interwoven. Here, the interwoven heat exchanger tubes may be offset with respect to one another by 180° about the respective helix axes. A heat exchanger tube that is arranged between two corresponding heat exchanger tubes may be correspondingly interwoven with both of the adjacent heat exchanger tubes.

In one form, the heat exchanger assembly has at least two heat exchanger tubes that are connected in series or parallel with respect to a flow of the heat exchanger fluid. At the ends, the heat exchanger tubes may be correspondingly connected in series or parallel via two or more fluid distributors. Alternatively, groups of two or more tubes may be connected in series or parallel, resulting in a split section design.

In one form, the helix axis of at least one heat exchanger tube is at least partially curved. The shaping of the heat exchanger assembly can thus be adapted to the respectively available structural space. It would also be possible for the heat exchanger assembly to give way to a possible object, that is, to be led around the object.

In another form, at least one flow-manipulating directing element is arranged in at least one heat exchanger tube. The directing element may extend from an inner lateral surface of the heat exchanger tube to a point at a distance from the tube centerline of the heat exchanger tube. It is also possible for two or more directing elements to be provided in the heat exchanger tube so as to be circumferentially offset with respect to one another about the tube centerline. The directing elements yet further enhance the positive effect of the thorough mixing of the heat exchanger fluid flowing within the heat exchanger tube.

In yet another form, the directing element is configured as a radially inwardly and rectilinearly extending rib, as a radially inwardly extending pin, or as a helically extending rib.

In one form, at least one heat exchanger tube has a circular, elliptical or oval cross-sectional area. In relation to a conventional flat tube, each of these tube shapes results in less of an internal pressure drop within the heat exchanger fluid or within the heat exchanger tube.

In another form, the heat exchanger assembly is produced at least in part by additive manufacturing. For example, the heat exchanger tube may be produced by additive manufacturing, in particular a 3D printing process, such that any curved or arcuate profiles of the heat exchanger tube can be produced. This for example also allows the heat exchanger tube or the heat exchanger assembly to be individually structurally adapted to adjacent vehicle parts, for example a vehicle front grille. The fluid distributors may alternatively or additionally also be produced by additive manufacturing, for example in order to be able to enhance them in terms of their shape and volume. Furthermore, in this way, the fluid distributors can for example be produced monolithically with the heat exchanger tube. If the fluid distributors and heat exchanger tubes are produced separately, for example by 3D printing, they can be suitably connected, for example integrally bonded or welded.

In one form, a heat exchanger assembly for a motor vehicle includes an inflow side, an outflow side, and a plurality of helically extending heat exchanger tubes through which a heat exchanger fluid flows. The plurality of helically extending heat exchanger tubes are positioned between the inflow side and the outflow side. A medium flows along a throughflow direction past the plurality of helically extending heat exchanger tubes from the inflow side to the outflow side. The plurality of helically extending heat exchanger tubes define respective helix axes extending transversely with respect to the throughflow direction of the heat exchanger assembly. The respective helix axes extend parallel to one another and are spaced from one another such that one helically extending heat exchanger tube of the plurality of helically extending heat exchanger tubes loops around another helically extending heat exchanger tube of the plurality of helically extending heat exchanger tubes at uniform intervals along the helix axes. The plurality of helically extending heat exchanger tubes are additively manufactured.

In variations of the heat exchanger assembly of the above paragraph, at least one heat exchanger fin extends transversely with respect to the helix axes; the plurality of helically extending heat exchanger tubes are connected in series or in parallel with respect to a flow of the heat exchanger fluid; the respective helix axes of the plurality of helically extending heat exchanger tubes are at least partially curved; one helix axis of the respective helix axes is at least partially curved; the one helix axis includes multiple arches; each helically extending heat exchanger tube of the plurality of helically extending heat exchanger tubes includes at least one flow-manipulating directing element arranged inside; the flow-manipulating directing element consists of a radially inwardly and rectilinearly extending rib, a radially inwardly extending pin, or a helically extending rib; and each helically extending heat exchanger tube of the plurality of helically extending heat exchanger tubes has a circular, elliptical or oval cross-sectional area.

In another form, a heat exchanger assembly for a motor vehicle includes an inflow side, an outflow side, and a plurality of helically extending heat exchanger tubes through which a heat exchanger fluid flows. The plurality of helically extending heat exchanger tubes are positioned between the inflow side and the outflow side. A medium flows along a throughflow direction past the plurality of helically extending heat exchanger tubes from the inflow side to the outflow side. The plurality of helically extending heat exchanger tubes define respective helix axes extending transversely with respect to the throughflow direction of the heat exchanger assembly. The respective helix axes extend parallel to one another and are spaced from one another such that one helically extending heat exchanger tube of the plurality of helically extending heat exchanger tubes loops around two adjacent helically extending heat exchanger tubes of the plurality of helically extending heat exchanger tubes at uniform intervals along the helix axes.

Further areas of applicability will become apparent from the description provided herein. It should be understood that the description and specific examples are intended for purposes of illustration only and are not intended to limit the scope of the present disclosure.

### DRAWINGS

Further advantageous refinements of the invention are disclosed in the subclaims and in the following description of the figures, in which:

FIGS. 1A-1C show schematic illustrations of an exemplary heat exchanger assembly according to the principles of the present disclosure;

FIGS. 2A-2C show schematic illustrations of another exemplary heat exchanger assembly according to the principles of the present disclosure;

FIGS. 3A-3C show schematic illustrations of yet another exemplary heat exchanger assembly according to the principles of the present disclosure;

FIG. 4 shows a schematic plan view of another exemplary heat exchanger assembly according to the principles of the present disclosure;

FIG. 5 shows a schematic plan view of yet another exemplary heat exchanger assembly according to the principles of the present disclosure;

FIGS. 6A and 6B show schematic illustrations of a heat exchanger tube according to the principles of the present disclosure having directing elements;

FIGS. 7A and 7B show schematic illustrations of another heat exchanger tube according to the principles of the present disclosure having directing elements;

FIGS. 8A and 8B show schematic illustrations of yet another heat exchanger tube according to the principles of the present disclosure having directing elements; and

FIGS. 9A and 9B show schematic illustrations of yet another heat exchanger tube according to the principles of the present disclosure having directing elements.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

In the various figures, identical parts are always denoted by the same reference designations, for which reason said parts will generally also be described only once.

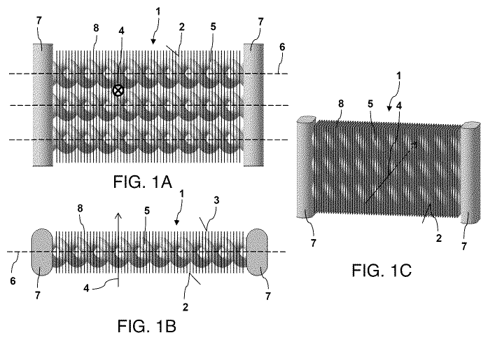

FIGS. 1A-1C show schematic illustrations of an exemplary form of a heat exchanger assembly 1 according to the present disclosure for a motor vehicle. FIG. 1A shows a frontal view of the heat exchanger assembly 1. FIG. 1B shows a plan view of the heat exchanger assembly 1. FIG. 1C shows a perspective illustration of the heat exchanger assembly 1. The heat exchanger assembly 1 may be produced at least in part by additive manufacturing.

The heat exchanger assembly 1 has an inflow side 2, which in FIGS. 1A-1C faces toward the viewer and which is arranged at the bottom in the plane of the drawing in FIG. 1B. The inflow side 2 may also be referred to as the front side of the heat exchanger assembly 1, which can be impinged on by a medium, in particular air, while the motor vehicle is in motion. In the exemplary form shown, the inflow side 2 is configured as a planar and rectangular surface.

The heat exchanger assembly 1 furthermore has an outflow side 3, which in FIGS. 1A and 1C faces away from the viewer and which is arranged at the top in the plane of the drawing in FIG. 1B. The outflow side 3 may also be referred to as the rear side of the heat exchanger assembly 1, from which the medium, in particular air, that has flowed through the heat exchanger assembly 1 emerges from the heat exchanger assembly 1 again while the motor vehicle is in motion. In the exemplary form shown, the outflow side 3 is configured as a planar and rectangular surface and is arranged parallel to the inflow side 2 of the heat exchanger assembly 1.

The heat exchanger assembly 1 furthermore has a throughflow direction which is indicated by an arrow 4 and in which a medium, in particular air, can flow through the heat exchanger assembly 1 from the inflow side 2 to the outflow side 3. Not illustrated in the figures is a fan, which is associated with the heat exchanger assembly 1 and which can boost the flow through the heat exchanger assembly 1 or cause the flow in the first place when the motor vehicle is at a standstill.

The heat exchanger assembly 1 according to the exemplary form in FIGS. 1A-1C may furthermore have, for example, six heat exchanger tubes 5 which each extend helically and through which a heat exchanger fluid can flow or flows, wherein a helix axis 6 of a helix formed by the particular heat exchanger tube 5 extends transversely with respect to the throughflow direction 4 of the heat exchanger assembly 1. In the exemplary form illustrated in FIGS. 1A-1C, three tube pairs each consisting of two heat exchanger tubes 5 are arranged spaced apart from one another in a row and one above the other in the plane of the drawing in FIG. 1A, wherein the heat exchanger tubes 5 of each tube pair are configured and arranged relative to one another, so as to define or have a common helix axis 6. The heat exchanger tubes 5 of a tube pair loop around one another and form a double helix. Instead of the three tube pairs that are illustrated by way of example, it is self-evidently also possible for more or fewer tube pairs to be provided.

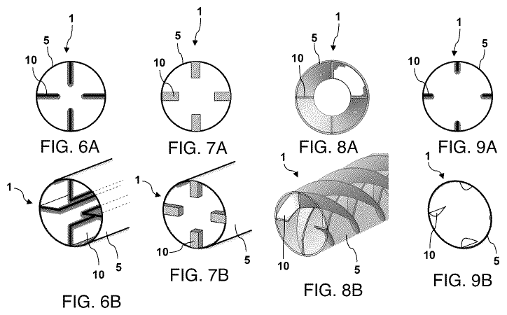

Each heat exchanger tube 5 has a circular cross-sectional area. In at least one heat exchanger tube 5, there may be arranged at least one flow-manipulating directing element, which may be configured in particular in accordance with any one of the exemplary forms shown in FIGS. 6A and 6B, 7A and 7B, 8A and 8B, and 9A and 9B. The heat exchanger tubes 5 are connected in parallel, in terms of a flow of the heat exchanger fluid, via fluid distributors 7 at the ends, each fluid distributor 7 being configured as a vertical tube.

The heat exchanger assembly 1 furthermore has a multiplicity of heat exchanger fins 8 which extend transversely with respect to the helix axes 6 and parallel to the throughflow direction 4. The heat exchanger fins 8 are in particular arranged parallel to one another and uniformly spaced apart from one another in a row in the plane of the drawing in FIG. 1A. The heat exchanger tubes 5 are led through the heat exchanger fins 8 and fixedly connected thereto, whereby the stability of the heat exchanger assembly 1 is increased. The heat exchanger fins 8 extend from the inflow side 2 to the outflow side 3 of the heat exchanger assembly 1 and furthermore, in part, define the throughflow direction 4 of the heat exchanger assembly 1.

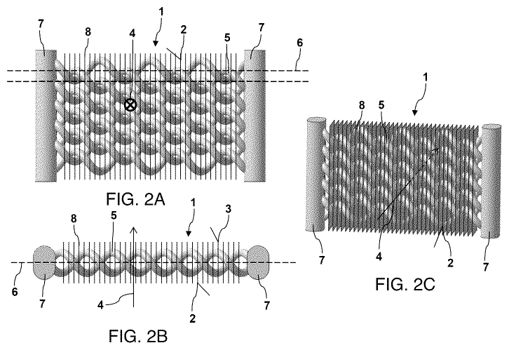

FIGS. 2A-2C show schematic illustrations of another exemplary form of a heat exchanger assembly 1 according to the present disclosure for a motor vehicle. FIG. 2A shows a frontal view of the heat exchanger assembly 1. FIG. 2B shows a plan view of the heat exchanger assembly 1. FIG. 2C shows a perspective illustration of the heat exchanger assembly 1. The heat exchanger assembly 1 may be produced at least in part by additive manufacturing.

The heat exchanger assembly 1 has an inflow side 2, which in FIGS. 2A and 2C faces toward the viewer and which is arranged at the bottom in the plane of the drawing in FIG. 2B. The inflow side 2 may also be referred to as the front side of the heat exchanger assembly 1, which can be impinged on by a medium, in particular air, while the motor vehicle is in motion. In the exemplary form shown, the inflow side 2 is configured as a planar and rectangular surface.

The heat exchanger assembly 1 furthermore has an outflow side 3, which in FIGS. 2A and 2C faces away from the viewer and which is arranged at the top in the plane of the drawing in FIG. 2B. The outflow side 3 may also be referred to as the rear side of the heat exchanger assembly 1, from which the medium, in particular air, that has flowed through the heat exchanger assembly 1 emerges from the heat exchanger assembly 1 again while the motor vehicle is in motion. In the exemplary form shown, the outflow side 3 is configured as a planar and rectangular surface and is arranged parallel to the inflow side 2 of the heat exchanger assembly 1.

The heat exchanger assembly 1 furthermore has a throughflow direction which is indicated by an arrow 4 and in which a gas can flow through the heat exchanger assembly 1 from the inflow side 2 to the outflow side 3. Not illustrated in the figures is a fan, which is associated with the heat exchanger assembly 1 and which can boost the flow through the heat exchanger assembly 1 or cause said flow in the first place when the motor vehicle is at a standstill.

The heat exchanger assembly 1 in the exemplary form illustrated in FIG. 2 furthermore has ten heat exchanger tubes 5 which each extend helically and through which a heat exchanger fluid can flow or flows, wherein a helix axis 6 of a helix formed by the particular heat exchanger tube 5 extends transversely with respect to the throughflow direction 4 of the heat exchanger assembly 1. The helices of the heat exchanger tubes 5 extend parallel to one another in the vertical direction as seen in FIG. 2A and are spaced from one another such that adjacent heat exchanger tubes 5 loop around one another, that is to say are interwoven with one another at uniform intervals along the helix axes 6. Here, the outer (uppermost and lowermost in the plane of the drawing in FIG. 2A) heat exchanger tubes 5 each loop around only one adjacent heat exchanger tube 5, whereas interposed heat exchanger tubes 5 each loop around two adjacent heat exchanger tubes 5. It is self-evidently also possible for more or fewer than ten heat exchanger tubes 5 to be provided in the exemplary form in FIGS. 2A-2C.

Each heat exchanger tube 5 has a circular cross-sectional area. In at least one heat exchanger tube 5, there may be arranged at least one flow-manipulating directing element, which may be configured in particular in accordance with any one of the exemplary forms shown in FIGS. 6A and 6B, 7A and 7B, 8A and 8B, and 9A and 9B. The heat exchanger tubes 5 are connected in parallel, in terms of a flow of the heat exchanger fluid, via fluid distributors 7 at the ends, each fluid distributor 7 being configured as a vertical tube.

The heat exchanger assembly 1 furthermore has a multiplicity of heat exchanger fins 8 which extend transversely with respect to the helix axes 6 and parallel to the throughflow direction 4. The heat exchanger fins 8 are in particular arranged parallel to one another and uniformly spaced apart from one another in a row. The heat exchanger tubes 5 are led through the heat exchanger fins 8 and fixedly connected thereto, whereby the stability of the heat exchanger assembly 1 is increased. The heat exchanger fins 8 extend from the inflow side 2 to the outflow side 3 of the heat exchanger assembly 1 and furthermore, in part, define the throughflow direction 4 of the heat exchanger assembly 1.

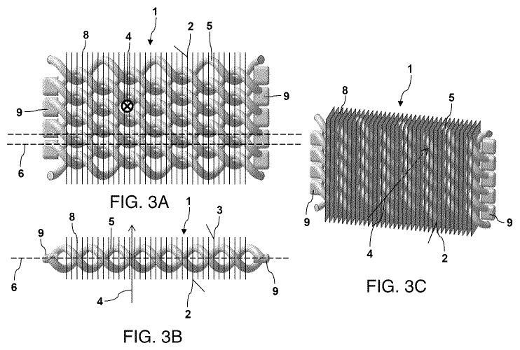

FIGS. 3A-3C show schematic illustrations of another exemplary form of a heat exchanger assembly 1 according to the present disclosure for a motor vehicle. FIG. 3A shows a frontal view of the heat exchanger assembly 1. FIG. 3B shows a plan view of the heat exchanger assembly 1. FIG. 3C shows a perspective illustration of the heat exchanger assembly 1. The heat exchanger assembly 1 may be produced at least in part by additive manufacturing.

The heat exchanger assembly 1 has an inflow side 2, which in FIGS. 3A and 3C faces toward the viewer and which is arranged at the bottom in the plane of the drawing in FIG. 3B. The inflow side 2 may also be referred to as the front side of the heat exchanger assembly 1, which can be impinged on by a medium, in particular air, while the motor vehicle is in motion. In the exemplary form shown, the inflow side 2 is configured as a planar and rectangular surface.

The heat exchanger assembly 1 furthermore has an outflow side 3, which in FIGS. 3A and 3C faces away from the viewer and which is arranged at the top in the plane of the drawing in FIG. 3B. The outflow side 3 may also be referred to as the rear side of the heat exchanger assembly 1, from which the medium, in particular air, that has flowed through the heat exchanger assembly 1 emerges from the heat exchanger assembly 1 again while the motor vehicle is in motion. In the exemplary form shown, the outflow side 3 is configured as a planar and rectangular surface and is arranged parallel to the inflow side 2 of the heat exchanger assembly 1.

The heat exchanger assembly 1 furthermore has a throughflow direction which is indicated by an arrow 4 and in which a medium, in particular air, can flow through the heat exchanger assembly 1 from the inflow side 2 to the outflow side 3. Not illustrated in the figures is a fan, which is associated with the heat exchanger assembly 1 and which can boost the flow through the heat exchanger assembly 1 or cause said flow in the first place when the motor vehicle is at a standstill.

The heat exchanger assembly 1 in the exemplary form illustrated in FIGS. 3A-3C furthermore has ten heat exchanger tubes 5 which each extend helically and through which a heat exchanger fluid can flow or flows, wherein a helix axis 6 of a helix formed by the particular heat exchanger tube 5 extends transversely with respect to the throughflow direction 4 of the heat exchanger assembly 1. The helices of the heat exchanger tubes 5 extend parallel to one another in the vertical direction as seen in FIG. 3A and are spaced from one another such that adjacent heat exchanger tubes 5 loop around one another, that is to say are interwoven with one another at uniform intervals along the helix axes 6. Here, the outer (uppermost and lowermost in the plane of the drawing in FIG. 3A) heat exchanger tubes 5 each loop around only one adjacent heat exchanger tube 5, whereas interposed heat exchanger tubes 5 each loop around two adjacent heat exchanger tubes 5.

Each heat exchanger tube 5 has a circular cross-sectional area. In at least one heat exchanger tube 5, there may be arranged at least one flow-manipulating directing element, which may be designed in particular in accordance with any one of the exemplary forms shown in FIGS. 6A and 6B, 7A and 7B, 8A and 8B, and 9A and 9B.

The heat exchanger tubes 5 are connected in series with respect to a flow of the heat exchanger fluid. For this purpose, instead of the fluid distributors from FIGS. 1A-1C and 2A-2C, multiple connecting distributors 9 are provided which are arranged in a row one above the other and which each communicatively connect two heat exchanger tubes 5 to one another. The heat exchanger fluid is introduced into one outer, for example uppermost, heat exchanger tube 5 and is discharged from the other outer, for example lowermost, heat exchanger tube 5. Here, the heat exchanger tube 5 which is uppermost in the plane of the drawing in FIG. 3A is introduced via its right-hand end in the plane of the drawing into the uppermost connecting distributor 9, which is not illustrated for the sake of clarity. The heat exchanger fluid would then be introduced into the left-hand end of the uppermost heat exchanger tube 5. Correspondingly, the heat exchanger tube 5 which is lowermost in the plane of the drawing in FIG. 3A is introduced via its right-hand end in the plane of the drawing into the lowermost connecting distributor 9, which is not illustrated for the sake of clarity. The heat exchanger fluid is then discharged from the left-hand end of the lowermost heat exchanger tube 5. The described flow direction of the heat exchanger fluid should self-evidently be understood merely as an example, and may also be opposite to the described flow direction. It is self-evidently also possible for more or fewer than ten heat exchanger tubes 5 to be provided in the exemplary form in FIGS. 3A-3C.

The heat exchanger assembly 1 furthermore has a multiplicity of heat exchanger fins 8 which extend transversely with respect to the helix axes 6 and parallel to the throughflow direction 4. The heat exchanger fins 8 are in particular arranged parallel to one another and uniformly spaced apart from one another in a row. The heat exchanger tubes 5 are led through the heat exchanger fins 8 and fixedly connected thereto, whereby the stability of the heat exchanger assembly 1 is increased. The heat exchanger fins 8 extend from the inflow side 2 to the outflow side 3 of the heat exchanger assembly 1 and furthermore, in part, define the throughflow direction 4 of the heat exchanger assembly 1.

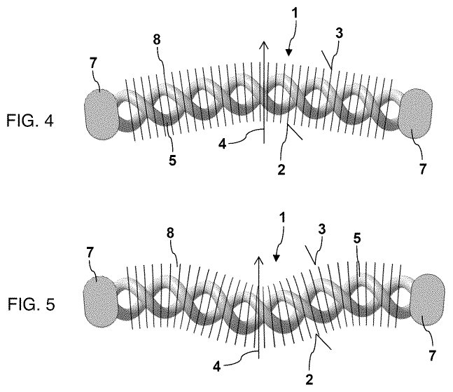

FIG. 4 shows a schematic plan view of another exemplary form of a heat exchanger assembly 1 according to the disclosure for a motor vehicle. The heat exchanger assembly 1 may be produced at least in part by additive manufacturing.

The design in the exemplary form according to FIG. 4 may be similar or identical to the exemplary form in FIGS. 1A to 1C, to the entire description of which reference is hereby made.

By contrast to the configuration according to FIGS. 1A to 1C, the heat exchanger assembly 1 is arched, that is to say curved, wherein the inflow side 2 is in particular concavely arched and the outflow side 3 is in particular convexly arched. It would self-evidently also be possible for the inflow side 2 and the outflow side 3 to be arched oppositely to the illustrated exemplary form, that is to say convexly/concavely. Here, the heat exchanger assembly 1 exhibits one change in direction from the left-hand fluid distributor 7 as seen in the plane of the drawing to the right-hand fluid distributor 7, or vice versa. Here, the helix axes (not specifically shown) of the heat exchanger tubes 5 have a C-shaped curvature in a central region of the heat exchanger assembly 1. The inflow side 2 and the outflow side 3 of the heat exchanger assembly 1 are thus also correspondingly curved.

It self-evidently also falls within the scope of the present disclosure for the heat exchanger assemblies 1 according to the exemplary forms in FIGS. 2A-2C and 3A-3C to be correspondingly arched, that is to say configured with a curvature.

FIG. 5 shows a schematic plan view of a further exemplary form of a heat exchanger assembly 1 according to the present disclosure for a motor vehicle. The heat exchanger assembly 1 may be produced at least in part by additive manufacturing.

The design in the exemplary form according to FIG. 5 may be similar or identical to the exemplary form in FIGS. 1A to 1C, to the entire description of which reference is hereby made.

By contrast to the configuration according to FIGS. 1A to 1C, the heat exchanger assembly 1 is multiply arched, that is to say multiply curved, wherein the inflow side 2 and the outflow side 3 are in particular W-shaped. It would self-evidently also be possible for the inflow side 2 and the outflow side 3 to be arched oppositely to the illustrated exemplary form, that is to say in an M shape. Here, the heat exchanger assembly 1 in the exemplary form illustrated in FIG. 5 exhibits three changes in direction from the left-hand fluid distributor 7 as seen in the plane of the drawing to the right-hand fluid distributor 7, or vice versa. The inflow side 2 and the outflow side 3 of the heat exchanger assembly 1 are thus also correspondingly curved. The helix axes (not specifically shown) of the heat exchanger tubes 5 are correspondingly W-shaped. The inflow side 2 and the outflow side 3 of the heat exchanger assembly 1 are thus also, in particular, W-shaped.

It self-evidently also falls within the scope of the disclosure for the heat exchanger assemblies 1 according to the exemplary forms in FIGS. 2A-2C and 3A-3B to be correspondingly arched, that is to say multiply curved.

FIGS. 6A and 6B show schematic illustrations of a heat exchanger tube 5 of a further exemplary form of a heat exchanger assembly 1 according to the present disclosure for a motor vehicle. FIG. 6A shows an end view and FIG. 6B shows a perspective illustration of the heat exchanger tube 5.

Four directing elements 10 are arranged in the heat exchanger tube 5 so as to be uniformly circumferentially offset by in each case 90°, which directing elements each extend over the length of the heat exchanger tube 5 and are each configured as a radially inwardly and rectilinearly extending rib. In this form, the directing element 10 is longer than it is wide. The height of each directing element 10, the height being measured in a radial direction, is smaller than a radius of the heat exchanger tube 5, whereby the radially inner ends of the directing elements 10 are spaced from one another. The heat exchanger assembly 1 may otherwise correspond to any one of the exemplary forms shown above (e.g., FIGS. 1A-1C, 2A-2C, 3A-3C, 4 and 5).

FIGS. 7A and 7B show schematic illustrations of a heat exchanger tube 5 of another exemplary form of a heat exchanger assembly 1 according to the disclosure for a motor vehicle. FIG. 7A shows an end view and FIG. 7B shows a perspective illustration of the heat exchanger tube 5.

Four directing elements 10 are arranged in the heat exchanger tube 5 so as to be uniformly circumferentially offset by in each case 90°, which directing elements 10 each extend over only a small part of the length of the heat exchanger tube 5 and are each configured as a radially inwardly extending rectangular pin. In this form, the directing element 10 is wider than it is long. The height of each directing element 10, the height being measured in a radial direction, is smaller than a radius of the heat exchanger tube 5, whereby the radially inner ends of the directing elements 10 are spaced from one another. The directing elements 10 may be present in the heat exchanger tube 5 only at the ends thereof. Alternatively, such directing elements 10 may be correspondingly arranged for example at uniform intervals along the heat exchanger tube 5, in each case so as to be distributed uniformly in a circumferential direction. Here, a rectilinear sequence of rectangular directing elements 10 or a sequence of individual directing elements 10 may be such that a helix is formed, which helix is however interrupted along the heat exchanger tube 5. The heat exchanger assembly 1 may otherwise correspond to any one of the exemplary forms shown above (e.g., FIGS. 1A-1C, 2A-2C, 3A-3C, 4 and 5).

FIGS. 8A and 8B show schematic illustrations of a heat exchanger tube 5 of another exemplary form of a heat exchanger assembly 1 according to the present disclosure for a motor vehicle. FIG. 8A shows an end view and FIG. 8B shows a perspective and transparent illustration of the heat exchanger tube 5.

Four directing elements 10 are arranged in the heat exchanger tube 5 so as to be uniformly circumferentially offset by in each case 90°, which directing elements 10 each extend over the length of the heat exchanger tube 5 and are each configured as a helically extending rib. In this form, the directing element 10 is longer than it is wide. The height of each directing element 10, the height being measured in a radial direction, is smaller than a radius of the heat exchanger tube 5, whereby the radially inner ends of the directing elements 10 are spaced from one another. The directing element 10 may self-evidently be profiled, that is to say of vane-like design, for example. The heat exchanger assembly 1 may otherwise correspond to any one of the exemplary forms shown above (e.g., FIGS. 1A-1C, 2A-2C, 3A-3C, 4 and 5).

FIGS. 9A and 9B show schematic illustrations of a heat exchanger tube 5 of another exemplary form of a heat exchanger assembly 1 according to the present disclosure for a motor vehicle (not shown). FIG. 9A shows an end view and FIG. 9B shows a perspective illustration of the heat exchanger tube 5.

Four directing elements 10 are arranged in the heat exchanger tube 5 so as to be uniformly circumferentially offset by in each case 90°, which directing elements 10 each extend over only a small part of the length of the heat exchanger tube 5 and are each configured as a radially inwardly and rectilinearly extending rib. In this form, the directing element is wider than it is long. The height of each directing element 10, the height being measured in a radial direction and varying continuously over the length of the directing element 10, is smaller than a radius of the heat exchanger tube 5, whereby the radially inner ends of the directing elements 10 are spaced from one another. In particular, the height of each directing element 10 increases from zero to a maximum, and subsequently decreases again, with a shallower gradient, to zero. The directing elements 10 may be present in the heat exchanger tube 5 only at the ends thereof. Alternatively, such directing elements 10 may be correspondingly arranged for example at uniform intervals along the heat exchanger tube 5, in each case so as to be distributed uniformly in a circumferential direction. Here, a rectilinear sequence of such directing elements 10, or such a sequence of directing elements 10, may be such that a helix is generated, which helix is however interrupted along the heat exchanger tube 5. The heat exchanger assembly 1 may otherwise correspond to any one of the exemplary forms shown above (e.g., FIGS. 1A-1C, 2A-2C, 3A-3C, 4 and 5).

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A heat exchanger assembly for a motor vehicle comprising:
an inflow side;
an outflow side; and
at least one helically extending heat exchanger tube through which a heat exchanger fluid flows, wherein a medium flows along a throughflow direction from the inflow side to the outflow side,
wherein a helix axis of a helix formed by the at least one helically extending heat exchanger tube extends transversely with respect to the throughflow direction of the heat exchanger assembly.

2. The heat exchanger assembly according to claim 1, wherein at least one heat exchanger fin extends transversely with respect to the helix axis.

3. The heat exchanger assembly according to claim 1, wherein the at least one helically extending heat exchanger tube includes at least two heat exchanger tubes configured and arranged relative to one another, so as to define a common helix axis.

4. The heat exchanger assembly according to claim 1, wherein the at least one helically extending heat exchanger tube includes at least two heat exchanger tubes defining respective helix axes, the respective helix axes extend parallel to one another and are spaced from one another such that the at least two heat exchanger tubes loop around one another at uniform intervals along the helix axes.

5. The heat exchanger assembly according to claim 1, wherein the at least one helically extending heat exchanger tube includes at least two heat exchanger tubes which are connected in series or in parallel with respect to a flow of the heat exchanger fluid.

6. The heat exchanger assembly according to claim 1, wherein the helix axis of the at least one helically extending heat exchanger tube is at least partially curved.

7. The heat exchanger assembly according to claim 1, wherein the at least one helically extending heat exchanger tube includes at least one flow-manipulating directing element arranged inside.

8. The heat exchanger assembly according to claim 7, wherein the at least one flow-manipulating directing element consists of a radially inwardly and rectilinearly extending rib, a radially inwardly extending pin, or a helically extending rib.

9. The heat exchanger assembly according to claim 1, wherein the at least one helically extending heat exchanger tube has a circular, elliptical or oval cross-sectional area.

10. The heat exchanger assembly according to claim 1, which is produced at least in part by additive manufacturing.

11. A heat exchanger assembly for a motor vehicle comprising:
an inflow side;
an outflow side; and
a plurality of helically extending heat exchanger tubes through which a heat exchanger fluid flows, the plurality of helically extending heat exchanger tubes positioned between the inflow side and the outflow side, a medium flows along a throughflow direction past the plurality of helically extending heat exchanger tubes from the inflow side to the outflow side,
wherein the plurality of helically extending heat exchanger tubes define respective helix axes extending transversely with respect to the throughflow direction of the heat exchanger assembly, the respective helix axes extend parallel to one another and are spaced from one another such that one helically extending heat exchanger tube of the plurality of helically extending heat exchanger tubes loops around another helically extending heat exchanger tube of the plurality of helically extending heat exchanger tubes at uniform intervals along the respective helix axes, and
wherein the plurality of helically extending heat exchanger tubes are additively manufactured.

12. The heat exchanger assembly according to claim 11, wherein at least one heat exchanger fin extends transversely with respect to the helix axes.

13. The heat exchanger assembly according to claim 11, wherein the plurality of helically extending heat exchanger tubes are connected in series or in parallel with respect to a flow of the heat exchanger fluid.

14. The heat exchanger assembly according to claim 11, wherein the respective helix axes of the plurality of helically extending heat exchanger tubes are at least partially curved.

15. The heat exchanger assembly accordingly to claim 11, wherein one helix axis of the respective helix axes is at least partially curved.

16. The heat exchanger assembly accordingly to claim 15, wherein the one helix axis includes multiple arches.

17. The heat exchanger assembly according to claim 11, wherein each helically extending heat exchanger tube of the plurality of helically extending heat exchanger tubes includes at least one flow-manipulating directing element arranged inside.

18. The heat exchanger assembly according to claim 17, wherein the at least one flow-manipulating directing element consists of a radially inwardly and rectilinearly extending rib, a radially inwardly extending pin, or a helically extending rib.

19. The heat exchanger assembly according to claim 11, wherein each helically extending heat exchanger tube of the plurality of helically extending heat exchanger tubes has a circular, elliptical or oval cross-sectional area.

20. A heat exchanger assembly for a motor vehicle comprising:
an inflow side;
an outflow side; and
a plurality of helically extending heat exchanger tubes through which a heat exchanger fluid flows, the plurality of helically extending heat exchanger tubes positioned between the inflow side and the outflow side, a medium flows along a throughflow direction past the plurality of helically extending heat exchanger tubes from the inflow side to the outflow side,
wherein the plurality of helically extending heat exchanger tubes define respective helix axes extending transversely with respect to the throughflow direction of the heat exchanger assembly, the respective helix axes extend parallel to one another and are spaced from one another such that one helically extending heat exchanger tube of the plurality of helically extending heat exchanger tubes loops around two adjacent helically extending heat exchanger tubes of the plurality of helically extending heat exchanger tubes at uniform intervals along the respective helix axes.
